(19) United States
(12) Patent Application Publication
(10) Pub. No.: US 2020/0256280 A1
(43) Pub. Date: Aug. 13, 2020

(54) ENGINE COVER WITH AN INTEGRAL TOLERANCE COMPENSATED SHAFT SEAL AND METHOD

(71) Applicant: MANN+HUMMEL GmbH, Ludwigsburg (DE)

(72) Inventors: Dan Huff, Mattawan, MI (US); Bruce Wakefield, Sturgis, MI (US)

(21) Appl. No.: 16/825,407

(22) Filed: Mar. 20, 2020

Related U.S. Application Data
(60) Provisional application No. 62/822,135, filed on Mar. 22, 2019.

(51) Int. Cl. F02F 11/00; B29C 69/00

(52) U.S. Cl. CPC F02F 11/00; F16J 15/16; B29C 69/00

(57) ABSTRACT

A thermoplastic engine cover for an internal combustion engine has a plurality of mounting holes for mounting the thermoplastic engine cover to an internal combustion engine. At least two datum locator formed on or arranged on the thermoplastic engine cover. At least one through opening configured to receive a rotatable shaft of the internal combustion engine. The at least one through opening has an internal diameter sized to provide an annular clearance gap between the seal carrier and an adjacent circumferential wall of the at least one through opening, to allow final positioning of the seal in the annular clearance gap to a final position in which the seal and seal carrier are positioned in a dimensionally correct position relative to the at least two datum locators. The seal carrier is then welded to the thermoplastic engine cover.

### CROSS-REFERENCE TO RELATED APPLICATION

This application claims the benefit of U.S. Provisional Application No. 62/822,135, filed 22 Mar. 2019.

### TECHNICAL FIELD

The present invention relates to a thermoplastic front engine cover with an integral crankshaft seal.

### BACKGROUND OF THE INVENTION

This section provides background information related to the present disclosure and is not necessarily prior art.

Internal combustion engines, such as for trucks, sport-utility vehicles and automobiles, can be provided with an engine cover to close a front side of the engine. Typically the engine cover may be required to accommodate rotating shafts which project through openings in the engine cover to an exterior of the engine, for example, intake/exhaust valve timing shafts and/or the engine crankshaft.

Design requirements for engine covers may have requirements for cost, weight, structural strength, and sometimes for seals, particularly for rotating components such as the crankshaft and/or intake/exhaust valve timing shafts. There is increasing customer demand for lower cost solutions with a lower part weight and the delivery of better fuel economy, all without compromising engine durability, performance, and shaft sealing integrity.

Internal combustion engine covers which are formed of metallic materials, such a steel or aluminum, are well known in the art. Also know in the art are metallic engine covers which may have shaft seals and/or shaft bearings integrated with and mount on the engine cover.

Typically the engine cover may be required to accommodate rotating shafts which project through openings in the engine cover to an exterior of the engine, for example, intake/exhaust valve timing shafts and the engine crankshaft.

### SUMMARY OF THE INVENTION

This section provides a general summary of the disclosure, and is not a comprehensive disclosure of its full scope and all of its features.

In one aspect of the invention, the present disclosure provides an engine front cover which is adapted to mount or mount with fasteners onto a front side of an internal combustion engine. The engine cover, in the present inventive disclosure is preferably formed of an injection molded thermoplastic material or thermoplastic resin. The engine cover may advantageously close off or close over a face of the internal combustion engine and may define at least one through opening for accommodating at least one rotating engine component. The rotating engine component may (in some cases) be supported on the engine cover and may project through the engine cover. The rotating engine component includes rotating shafts, preferably an engine crankshaft and/or one or more intake/exhaust valve timing shafts.

In a further aspect of the invention, the engine cover is made of an injection molded thermoplastic and may include one or more annular or cylindered mounting projections formed on a surface of the engine cover, and/or a mounting depression or pocket formed into the surface of the engine cover.

In some aspects of the invention, a shaft seal having a seal carrier is provided for mounting to the engine cover in the though opening. Preferably the mounting projection (if provided) and/or the through opening has a larger dimensional size that the outer diameter of the seal carrier such that the seal carrier can be arranged in the mounting projection and/or the through opening with dimensional tolerance permitting the seal carrier to be moved or displaced in the mounting projection and/or the through opening to compensate for tolerance variations and accommodate dimensional compliance with the internal combustion engine.

It is advantageous to provide an engine mounting cover having the dimensional compensation for tolerance variations and dimensional compliance to permit the seal/seal carrier to be shifted or moved relative to the engine cover into a correct/final position before permanently mounting the seal/seal carrier to the engine cover. The dimensional shift or movement relative to the engine cover during mounting providing a desired dimensionally precise mounting of the sea/seal carrier relative to a position of the engine shaft to correct for dimensional alignment differences between the seal carrier and the engine shaft (ex: engine crankshaft or intake/exhaust valve timing shaft) to be received into the shaft seal. Preferably, this dimension alignment is done before the seal carrier is permanently fixed onto the engine cover and before the engine cover is eventually mounted onto the engine.

The dimensional compensation for tolerance variations and dimensional compliance is advantageous for correcting for dimensional variations or tolerance in the engine cover, particularly when the engine cover is formed of an injection molded thermoplastic, thereby eliminating dimensional variation problems in thermoplastic engine covers of the prior art and solving a long standing problem in the art.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

The drawing are for illustrative purposes only of an example embodiment, and not all possible implementations, and are not intended to limit the scope of the present disclosure.

FIG. 1 is a schematic rear side view of a thermoplastic engine cover, consistent with the present disclosure;

FIG. 2 is a schematic rear-bottom perspective view of the thermoplastic engine cover of FIG. 1, consistent with the present disclosure; and

FIG. 3 is a sectional view of a front side of the thermoplastic engine cover of FIG. 1, the section taken through the seal carrier.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components related to a molded plastic engine cover. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

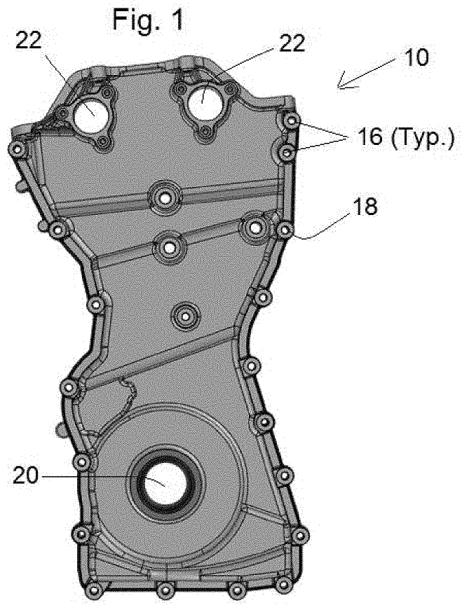

FIG. 1 depicts a schematic rear side view of a thermoplastic engine cover 10.

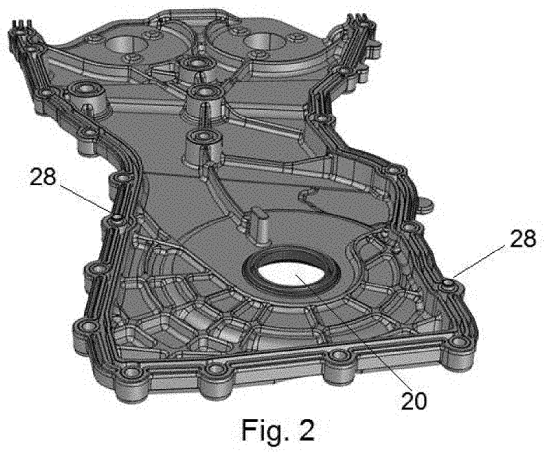

FIG. 2 is a schematic rear-bottom perspective view of the thermoplastic engine cover 10 of FIG. 1, and

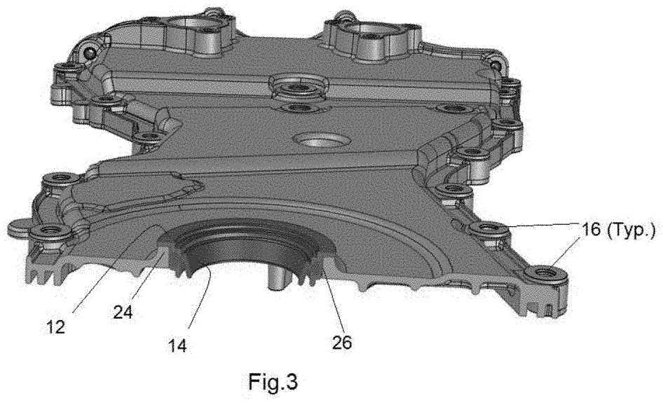

FIG. 3 is a sectional view of a front side of the thermoplastic engine cover 10 of FIG. 1, the section taken through the seal 14 and seal carrier 12.

The thermoplastic engine cover 10 may include a plurality of mounting holes 16 formed into the cover. Preferably a metallic compression limiter 18 may be arranged within at least some of the mounting holes 16. This is advantageous for directing compression applied by mounting screws of bolts onto the compression limiter 18 and away from the thermoplastic engine cover 10, so as to minimize plastic creep.

The thermoplastic engine cover 10 may include a though opening 20 for an engine crankshaft. Additionally, the thermoplastic engine cover 10 may include other through openings 22, for example, to accommodate one or more engine valve timing shafts.

As best shown in FIG. 3, the seal 14 with its seal carrier 12 is arranged in the mounting projection 24 surrounding the through opening 20 which, in this case, receives the engine crankshaft (not shown). To provide dimensional compensation for tolerance variations in the cover or engine and dimensional compliance, the mounting projection 24 and/or through opening 20 is provided with an annular clearance gap 26 between the outer side of the seal carrier 12 and the inner side of the annular mounting projection 24 and/or through opening 20. The annular clearance gap 26 allows the seal carrier 12 to be repositioned during mounting of the seal carrier 12 to the thermoplastic engine cover 10, so as to provide to correct or precise dimensional final position of the seal carrier 12 so as to correctly align with the crankshaft when the thermoplastic engine cover 10 is mounted to the engine.

As best seen in FIG. 2, the thermoplastic engine cover 10 includes at least two datum locators 28 formed on, or molded into the thermoplastic engine cover 10. In FIG. 2, the datum locations may, for example, be realized by features molded into the thermoplastic engine cover 10 or may be integrated into selected ones of the compression limiters 18. In the invention, the datum locators 28 are used to precisely position the seal carrier 12 within the annular clearance gap 26, relative to the datum locators 28. It is particularly preferred for the datum locators 28 to correspond to mounting holes 16 or compression limiters 18, as this correlates to final mounting alignment positions relative to the engine.

Once the seal carrier 12 is correctly positioned within the annular clearance gap 26, relative to the datum locators 28, the seal carrier 12 is welded to the thermoplastic engine cover 10 by a thermal melting process, preferably laser welding. The laser welding fixedly and permanently mounts the seal carrier 12 onto the thermoplastic engine cover 10. The welding forms a tight seal between the seal carrier 12 and the thermoplastic engine cover 10 at the through opening 20, thereby eliminating the need for a separate seal or seal joint for a fluid tight joint.

For example, as best seen in FIG. 3, the circumferential flange of the seal carrier 12 may be welded onto an end face annular mounting projection 24, or onto the circumference of the through opening 20.

Advantageously, the present invention provides compensation for the additional dimensional variation in plastic molded engine covers over prior art machined aluminum or metal engine covers, permitting thermoplastic engine covers with shaft seals to be to be widely and readily applied to engine applications where the dimensional variations of plastic injection molding would have previously precluded their use.

Also disclosed is a method for manufacturing a thermoplastic engine cover 10 having an integral tolerance compensated engine shaft seal 14. The method including the steps of:
providing a seal having a seal carrier;
injection molding a thermoplastic engine cover having:
   at least two datum locators;
   a through opening to receive an engine shaft;
   wherein the through opening is sized or provide an annular clearance gap between the seal carrier and the through opening, the annular clearance gap sized to allow positioning of the seal to compensate for the dimensional variation in the molded plastic engine cover;
positioning the seal carrier into the through opening within the annular clearance gap of the through opening;
aligning the seal carrier in the annular clearance gap to a dimensionally correct final position relative to the at least two datum locators;
welding the seal carrier to the thermoplastic engine cover to permanently fix the seal and seal carrier in the dimensionally correct position on the thermoplastic engine cover.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A thermoplastic engine cover for an internal combustion engine, comprising:
a plurality of mounting holes for mounting the thermoplastic engine cover to an internal combustion engine;
at least two datum locator formed on or arranged on the thermoplastic engine cover;
at least one through opening configured to receive a rotatable shaft of the internal combustion engine;
a shaft seal with a seal carrier, configured to seal the rotatable shaft at the at least one through opening to the thermoplastic engine cover;
wherein the at least one through opening has an internal diameter sized to provide an annular clearance gap between the seal carrier and an adjacent circumferential wall of the at least one through opening;
wherein the annular clearance gap is sized to allow final positioning of the seal in the annular clearance gap to a final position in which the seal and seal carrier are positioned in a dimensionally correct position relative to the at least two datum locators;
securely fixing the seal carrier to the thermoplastic engine cover while in the final position.

2. The thermoplastic engine cover according to claim 1, wherein
the seal carrier is fixed to the thermoplastic engine cover by welding.

3. The thermoplastic engine cover according to claim 2, wherein
seal carrier fluid tightly seals at the through opening to the thermoplastic engine cover.

4. The thermoplastic engine cover according to claim 1, further comprising:
compression limiters arranged in the plurality of mounting holes;
wherein the compression limiters at metallic and configured to remove compressive mounting loads from the thermoplastic engine cover.

5. The thermoplastic engine cover according to claim 1, wherein
the rotatable shaft is an engine crankshaft.

6. The thermoplastic engine cover according to claim 4, wherein
the at least two datum locator are either:
formed on the thermoplastic engine cover, or
integrated into respective ones of the compression limiters.

7. A method for manufacturing a thermoplastic engine cover according to claim 1, the method including:
providing a seal having a seal carrier;
Injection molding a thermoplastic engine cover having:
at least two datum locators;
a through opening to receive an engine shaft;
wherein the through opening is sized or provide an annular clearance gap between the seal carrier and the through opening, the annular clearance gap sized to allow positioning of the seal to compensate for the dimensional variation in the molded plastic engine cover;
positioning the seal carrier into the through opening within the annular clearance gap of the through opening;
aligning the seal carrier in the annular clearance gap to a dimensionally correct final position relative to the at least two datum locators;
welding the seal carrier to the thermoplastic engine cover to permanently fix the seal and seal carrier in the dimensionally correct position on the thermoplastic engine cover.
